(19) United States
(12) Patent Application Publication
(10) Pub. No.: US 2026/0358305 A1
(43) Pub. Date: Nov. 12, 2026

(54) OVERCOMPRESSING A FLUID ABOVE A TARGET PRESSURE IN AN ANALYZING DEVICE

(71) Applicant: Agilent Technologies, Inc., Santa Clara, CA (US)

(72) Inventors: Konstantin Shoykhet, Karlsruhe (DE); Thomas Ortmann, Straubenhardt/Ottenhausen (DE)

(21) Appl. No.: 19/125,144

(22) PCT Filed: Oct. 25, 2023
(86) PCT No.: PCT/IB2023/060760

§ 371 Date: Apr. 28, 2025

(30) Foreign Application Priority Data
Oct. 28, 2022 (DE) 10 2022 128 643.6

(51) Int. Cl. G01N 30/36; G01N 30/02

(52) U.S. Cl. CPC G01N 30/36; G01N 2030/027

(57) ABSTRACT

A method of controlling a fluid in an analyzing device for analyzing a fluidic sample, for example a chromatographic device, includes overcompressing the fluid to an overpressure above a target pressure, and subsequently reducing the pressure of the fluid towards the target pressure.

### CROSS-REFERENCE TO RELATED APPLICATIONS

This application is the national stage under 35 U.S.C. 371 of International Application No. PCT/IB2023/060760, filed Oct. 25, 2023; which claims priority to German Application No. DE 10 2022 128 643.6, filed Oct. 28, 2022; the entire contents of each of which are incorporated by reference herein.

### TECHNICAL FIELD

The present disclosure relates to a method and a control unit for controlling a fluid in an analyzing device for analyzing a fluidic sample, and an analyzing device.

### BACKGROUND

In an HPLC, a liquid (mobile phase) is typically moved through a so-called stationary phase (for example in a chromatographic column) at a very precisely controlled flow rate (for example in the range from microliters to milliliters per minute) and at a high pressure (typically from 20 to 1000 bar and above, currently up to 2000 bar) at which the compressibility of the liquid can be noticeable, in order to separate individual fractions of a sample liquid introduced into the mobile phase from one another. After passing through the stationary phase, the separated fractions of the fluidic sample are detected in a detector. Such an HPLC system is known for example from EP 0,309,596 B1 of the same applicant, Agilent Technologies, Inc.

In the operation of an analyzing device, in connection with the provision of a fluid, such as for example a mobile phase, artifacts can occur and as a result inaccurate or even erroneous analysis results can occur. The time effort in connection with an analysis can also be high as a result of undesired fluid properties.

### SUMMARY

There may be a need to handle a fluid in an analyzing device in such a way that an analysis can be carried out precisely and/or quickly.

According to an exemplary embodiment of the present disclosure, a method of controlling a fluid in an analyzing device for analyzing a fluidic sample is provided, wherein the method comprises overcompressing the fluid to an overpressure above a target pressure, and subsequently reducing the pressure of the fluid towards the target pressure.

According to another exemplary embodiment, a control unit for controlling a fluid in an analyzing device for analyzing a fluidic sample is provided, wherein the control unit is configured for overcompressing the fluid to an overpressure above a target pressure, and subsequently reducing the pressure of the fluid towards the target pressure.

According to a further exemplary embodiment, an analyzing device for analyzing a fluidic sample using a fluid is provided, wherein the analyzing device comprises a control unit with the above-described features for controlling the fluid.

In the context of the present application, the term “fluid” denotes in particular a liquid and/or a gas, optionally comprising solid particles.

In the context of the present application, the term “fluidic sample” denotes in particular a medium, further in particular a liquid, which contains the matter actually to be analyzed (for example a biological sample), such as for example a protein solution, a pharmaceutical sample, etc.

In the context of the present application, the term “mobile phase” denotes in particular a fluid, further in particular a liquid, which can for example serve as a carrier medium for transporting the fluidic sample, in particular between a fluid drive and a sample separating unit. Mobile phase can however also be used in a fluid conveying unit for influencing the fluidic sample. For example, the mobile phase can be a (for example organic and/or inorganic) solvent or a solvent composition (for example water and ethanol).

In the context of the present application, the term “analyzing device” can denote in particular a device that is able and configured to examine, in particular to separate, a fluidic sample, further in particular to separate it into different fractions. For example, such a sample separation can take place by means of chromatography or electrophoresis. For example, the analyzing device can be a liquid chromatography sample separating device.

In the context of the present application, the term “overcompressing a fluid to an overpressure above a target pressure” denotes in particular a compression of the fluid, so that its pressure, beyond a target pressure, is brought to a higher overpressure in this respect. Such an overcompression can be accomplished in particular by a pump or another fluid drive. In the case of such a pump, for example, a piston can be moved in the forward direction in such a way that the compression of the fluid beyond the target pressure is achieved. In order to accomplish an effective overcompression, the flow path of the fluid can be closed off behind or downstream of the pump or behind the fluid drive or downstream of the fluid drive, for example by an actively controllable valve, an overpressure valve or another measure for at least temporarily closing off a corresponding flow path.

In the context of the present application, the term “target pressure” denotes a (in particular predetermined) pressure value that is desired or is to be adjusted for a specific operation of the analyzing device. In particular, the target pressure can be a respective value of the fluid pressure in a fluidic system, also called “system pressure”, which prevails in the fluidic system shortly or immediately before the supply of the initially overcompressed and subsequently pressure-reduced fluid in the fluidic system. In the case of a configuration of the analyzing device as a chromatographic sample separating device, the target pressure can be a system pressure that is defined in a chromatographic separation method (that is to say a parameter set for defining a separation analysis of a specific sample). A target pressure can be constant over time or can change over an analysis (for example according to a predetermined function). However, it is also possible for a target pressure not to be predetermined but to be adjusted automatically on account of the separation method, on account of the properties of the analyzing device or on account of the operation thereof. The target pressure value can be lower than the pressure reached by the overcompressing, but can be higher than atmospheric pressure (for example 1 bar).

In the context of the present application, the term “reducing the pressure of the fluid towards the target pressure” denotes in particular that the fluid brought to the overpressure is (in particular only partially) decompressed after the overcompressing, so that the pressure of the fluid is reduced starting from the overpressure reached, in order either to reach the target pressure or to at least partially approach the target pressure. For example, the pressure reduction can be controlled such that, after the pressure reduction, the pressure of the fluid differs from the target pressure by less than 20%, in particular by less than 10%, further in particular by less than 5%. After the pressure reduction, the pressure of the fluid can thus correspond to the target pressure, be somewhat above the target pressure or be somewhat below the target pressure.

In the context of the present application, the term “control unit” denotes in particular an entity that is specifically configured for carrying out the overcompressing and the subsequent pressure reduction towards the target pressure. For example, the control unit can comprise a processor, comprise multiple processors or be configured as part of a processor, which is or are set up in terms of programming in order to carry out the method. For example, the control unit can process or execute a correspondingly configured control software for this purpose, which is configured in terms of programming for overcompressing and subsequent pressure reduction. Such a control software can also comprise parameters for carrying out such a method, for example a parameter specifying the overpressure, a parameter specifying the target pressure and/or one or multiple parameters that specify or specify the time course of the pressure.

According to an exemplary embodiment of the present disclosure, in an analyzing device for analyzing a fluidic sample (for example a chromatographic sample separating device), a fluid (for example the fluidic sample itself and/or a mobile phase that is used for analyzing the fluidic sample, or another working fluid or auxiliary fluid) is not brought directly to a target pressure, but in an at least two-stage method is brought indirectly to the target pressure or at least approximately (for example asymptotically approximately) the target pressure. For this purpose firstly the fluid is specifically compressed more than is necessary to achieve the target pressure, that is to say brought to a higher pressure than the desired target pressure. Then the pressure of the overcompressed fluid is reduced in order to approach it from the target pressure from the too high pressure value or in order to achieve the target pressure even exactly or at least asymptotically. This procedure has advantages. During the compression, heating of the fluid occurs, which—when the fluid is brought to target pressure—is followed by cooling. If specifically—as conventional—a “bringing to pressure” of a fluid is carried out in an analyzing device directly to the target pressure, the resulting thermal effects of the cooling of the fluid can lead to volume errors or flow rate errors occurring during the subsequent processing (such as conveying, storing, aliquoting etc. of the fluid), which influence the analysis of the fluidic sample in an undesired manner or impair the accuracy or speed thereof. In order to completely or partially compensate for such thermal effects, according to an exemplary embodiment of the present disclosure, the fluid is firstly brought to an even higher pressure than the target pressure. As a result, especially strong heating of the fluid occurs. As a result, the heat release by the liquid is promoted, or the initial cooling process is accelerated. During the subsequent pressure reduction, the fluid cools rapidly and therefore achieves temperature compensation more quickly. If the fluid thus cools rapidly as a result of the subsequent pressure reduction and thereby approaches the target pressure, the aforementioned undesired thermal artifacts can be strongly suppressed or even completely eliminated. The analysis can therefore be carried out with fewer artifacts or even without artifacts. Consequently, the analysis can be operated with a higher analysis accuracy. Alternatively or additionally, the time for conditioning the fluid to the target pressure or to a pressure close to the target pressure can be shortened. Therefore, the analysis of a fluidic sample or individual phases or partial processes of the analysis can be carried out with increased accuracy and/or in an accelerated manner.

Additional configurations of the method, of the control unit and of the analyzing device are described below.

According to an exemplary embodiment, the method can comprise subsequently reducing the pressure of the fluid until the target pressure is reached. The method can thus be carried out in such a way that the control parameters are oriented such that, after the overcompressing and the pressure reduction, the processed fluid is actually substantially or even exactly at the target pressure. Alternatively, the control can ensure that, after the overcompressing and the subsequent pressure reduction, the pressure of the fluid deviates from the target pressure by less than ±10%, in particular less than ±5%, further in particular less than ±1%.

According to an exemplary embodiment, the method can comprise overcompressing and/or subsequently reducing the pressure by means of a fluid drive. For example, this can take place by means of a piston pump, in particular by means of advancing a piston of the piston pump for overcompressing and/or by means of retracting a piston of the piston pump for subsequently reducing the pressure. However, fluid drives other than piston pumps are possible. A fluid drive for driving the fluid can thus be controlled such that a pressure profile to be achieved, namely an overcompressing followed by a pressure reduction, towards the target pressure is accomplished by the fluid drive. For example, if the fluid drive comprises one or multiple piston pumps, the piston of the piston pump (in particular of a primary piston pump), which can reciprocate in a working space, can be subjected to a stronger forward movement than would be required for directly reaching the target pressure. As a result, the fluid can be overcompressed to the overpressure above the target pressure. If the piston of the piston pump is subsequently retracted, the overcompressed fluid can be specifically decompressed in order to accomplish a predetermined pressure reduction. Thus, the control unit can act on a fluid drive, in particular be or encompass a pump control of a piston pump. It is also possible for a fluid drive to comprise multiple pump stages, for example to comprise parallel and/or serial piston pumps. If the fluid drive is accomplished by two serially coupled piston pumps, for example, the primary piston can be controlled such that it effects the overcompressing and subsequent decompressing.

According to an exemplary embodiment, the method can comprise overcompressing the fluid to the overpressure by means of the fluid drive and by means of temporarily closing a fluid valve. Thus, the previously described fluid drive can interact with a corresponding fluid valve in order to jointly control the described method. If, for example, a piston of a piston pump of the fluid drive is subjected to a pronounced forward movement in order to overcompress the fluid, a fluid valve arranged downstream of this fluid drive can be closed such that the fluid cannot escape the pressure of the piston pump effecting the overcompression. For subsequent coupling of the pressure-conditioned fluid to a system, the fluid valve can then open.

According to an exemplary embodiment, the method can comprise actively controlling the fluid valve configured as an actively controllable fluid valve by means of temporarily closing for overcompressing and by means of opening for subsequently coupling the previously overcompressed and pressure-reduced fluid. According to an embodiment, the fluid valve is thus configured as an actively controllable fluid valve that is specifically controlled by means of the control unit. As a result, the periods of closing and opening can be precisely set.

According to another exemplary embodiment, the method can comprise controlling by means of configuring the fluid valve as an (in particular passive) overpressure valve, which can be configured to open only when a predetermined pressure value above the target pressure is reached. According to such an alternative configuration, the fluid valve can thus be configured as an overpressure valve that opens only at an overpressure that is above the target pressure and can correspond to the overpressure above the target pressure set during overcompressing. An active external control of such a fluid valve can then be dispensed with, which can facilitate the process control. For example, the opening pressure of such an overpressure valve can be at least 50 bar, in particular at least 100 bar, above the target pressure.

According to an exemplary embodiment, the fluid valve can be arranged at an outlet of the fluid drive or downstream of the fluid drive. For example, the fluid valve is arranged directly downstream of the fluid drive that executes the overcompressing and/or the pressure reduction. If the fluid drive is configured as a two-stage piston pump, the fluid valve configured in particular as an actively controllable valve or as an overpressure valve can be arranged directly at an outlet of the primary piston pump, that is to say between the primary piston pump and the secondary piston pump, in other words fluidically between the stages of the two-stage piston pump. Alternatively, the fluid valve can also be arranged downstream of the fluid drive, for example for separating a control flow path serving for the overcompressing and subsequent pressure reduction from a target flow path representing a fluidic target system.

According to an exemplary embodiment, the method can comprise overcompressing the fluid to the overpressure by means of the fluid drive and by means of temporarily shutting off a flow path portion containing the fluid drive. According to the described configuration, a flow path portion containing the fluid to be processed can also be shut off in a different way than with the described fluid valve in order to be able to subject the fluid in a defined way to an overcompression and a subsequent pressure reduction.

According to an exemplary embodiment, the fluid drive can form at least a part of an analytical pump for conveying the fluidic sample and mobile phase formed by the fluid to a sample separating unit of an analyzing device configured as a chromatographic sample separating device. It is thus possible that the method comprises, after the pressure reduction, introducing the fluidic sample into the fluid configured as a mobile phase for analyzing the fluidic sample, in particular for separating the fluidic sample in a sample separating unit, further in particular for chromatographically separating the fluidic sample. In a chromatographic sample separating device, a fluid drive configured as an analytical pump pumps a mobile phase, in particular a solvent composition, at high pressure towards the sample separating unit, in particular a chromatographic separation column. If, during the compression of the mobile phase, the latter is first overcompressed and subsequently subjected to a pressure reduction towards the target pressure or system pressure at the sample separating unit, a solvent composition of especially precise composition and flow rate can be provided. This leads to an especially precise chromatographic separation result. The above-described fluid first overcompressed and then pressure-reduced towards the target pressure can thus be the mobile phase.

According to an alternative or additional exemplary embodiment, the fluid drive can comprise a syringe pump for drawing up the fluidic sample formed by the fluid in an injector of an analyzing device configured as a chromatographic sample separating device. An injector of a chromatographic sample separating device can comprise, as a metering unit, a syringe pump in which a piston is retracted when a fluidic sample is drawn for example from a sample container through a sample needle into a sample receiving volume (for example a sample loop). Subsequently, the sample needle can be returned pressure-tightly into a seat. Before the fluidic sample received in the sample receiving volume is introduced into a separation path between an analytical pump and a sample separating unit, the piston of the syringe pump can be moved in the injector in the forward direction in order to overcompress the fluidic sample to an overpressure that is above a target pressure that can be for example the system pressure in the separation path between analytical pump and sample separating unit. Even before the fluidic sample is introduced from the sample receiving volume into the separation path, a pressure reduction can then be carried out with which the fluidic sample is brought in the direction of the target pressure or to the target pressure, for example in the direction of or to system pressure between analytical pump and sample separating unit. Only when the fluidic sample has sufficiently approached the target pressure or has reached the target pressure, the fluidic sample can be introduced into the separation path, for example by switching an injection valve. It can thereby be ensured that the fluidic sample at the correct pressure and also at the correct temperature is introduced into the separation path in the correct amount and without substantial disruption of the flow and pressure profile in the fluidic path. The precompression of the fluidic sample by the syringe pump in this case has the additional advantageous effect that excessive pressure surges when introducing the fluidic sample into the separation path under high pressure between analytical pump and sample separating unit are avoided. However, the overcompression of the fluidic sample compared to the system pressure by the syringe pump in the sample receiving volume may be completely or partially reduced by the described pressure reduction before the switching of the injection valve for introducing the fluidic sample into the mobile phase between analytical pump and sample separating unit takes place. In this way, an especially precise chromatographic separation can be achieved. Both pressure surges and flow rate fluctuations can namely be avoided thereby.

According to an exemplary embodiment, the overpressure reached by means of the overcompressing can be at least 1.1 times, in particular at least 1.2 times, further in particular at least twice, the target pressure. According to an exemplary embodiment, the overpressure reached by means of the overcompressing can be at most 1.5 times, in particular at most three times, the target pressure. In particular, the overpressure generated by the overcompression can be in a range from 1.1 times to 3 times, further in particular from 1.2 times to 1.5 times, the target pressure.

According to an exemplary embodiment, the overpressure reached by means of the overcompressing can be at least 50 bar, in particular at least 100 bar, higher than the target pressure. According to an exemplary embodiment, the overpressure reached by means of the overcompressing can be at most 500 bar, in particular at most 1000 bar, higher than the target pressure. In particular, the overpressure reached by means of the overcompressing can be in a range from 50 bar to 1000 bar, in particular in a range from 100 bar to 500 bar, higher than the target pressure.

According to an exemplary embodiment, the target pressure can be in a range from 200 bar to 2000 bar, in particular in a range from 1000 bar to 1500 bar. The values specified by way of example for the target pressure are thus typical values of a mobile phase under high pressure in a separation path of an HPLC.

According to an exemplary embodiment, the method can comprise controlling the overcompressing and the subsequent pressure reduction of the fluid such that compression-related thermal artifacts are thereby at least partially suppressed. The occurrence of the compression-related thermal artifacts, i.e. fluctuations or inaccuracies due to heating of the fluid by compression, followed by uncontrolled cooling with change of temperature, density and compressibility, to a temperature deviating from the fluid temperature in the flow path at the time of coupling the fluid volume to the system flow path, can be alleviated or completely eliminated by the controlled sequence of overcompressing and subsequent pressure reduction. The deviation of the temperature of the overcompressed and subsequently pressure-reduced fluid from the fluid temperature in the flow path and consequently the volume errors, flow rate errors, pressure fluctuations or other artifacts that can make the analysis in the analyzing device inaccurate or delay, can therefore be strongly suppressed.

According to an exemplary embodiment, at least a part of the at least partially suppressed compression-related thermal artifacts can be a flow rate deviation of the fluid due to heating caused by the overcompressing and subsequent cooling of the fluid. Descriptively, the strong heating followed by subsequent cooling of the fluid without the described sequence of overcompressing and subsequent pressure reduction can lead to an error in the flow rate of a fluid formed as a mobile phase, which can reduce the analysis accuracy or the analysis speed. Such undesired effects can be counteracted by the overcompressing before the pressure reduction.

According to an exemplary embodiment, the target pressure can be a pressure of a fluid in a target flow path downstream of a control flow path of the overcompressing and subsequent pressure reduction. Here, the target flow path can be in particular a flow path upstream of a sample separating unit, for example a chromatographic separation column. The control flow path, however, can be a flow path in which the fluid is controlled in the described way, in particular in the region of a fluid drive and an associated fluid valve. Target flow path and control flow path can be separated from one another for example by a fluid valve and can be fluidically coupled to one another by opening the fluid valve.

According to an exemplary embodiment, after the overcompressing, the method can comprise passively waiting for an at least partial thermal equalization of the overcompressed fluid with a thermal environment for the pressure reduction and only subsequently fluidically coupling the fluid to a flow path arranged downstream. According to the described embodiment, firstly the fluid can be overcompressed, that is to say brought to an overpressure above the target pressure that is likewise above atmospheric pressure. Thereafter, the overcompressed fluid can firstly be subjected to cooling that can be achieved by exchange with the thermal environment. Here, the thermal environment can comprise in particular any component of the analysis device and the thermodynamic periphery of the analysis device that is in thermal contact with the fluid. These can be for example components, groups or components of a piston pump of a fluid drive. It is also possible for a coupling of the fluid to an environment of the analysis device, for example to a laboratory environment, to enter into the thermal equalization. It is further possible for the fluid to be coupled thermally to a thermostat that can specify the temperature development of the overcompressed fluid especially precisely. After sufficient temperature compensation has taken place, the now pressure-reduced fluid can be coupled into a target flow path in a cooled state.

According to an exemplary embodiment, the method can comprise fluidically coupling the fluid to the flow path arranged downstream if, due to the passive waiting for the at least partial thermal equalization, the fluid has reached the target pressure. If the fluid brought to target pressure (or at least approaching the target pressure, in particular asymptotically) is coupled into a target flow path after it has already cooled sufficiently, the above-described thermal artifacts can advantageously be avoided.

According to an exemplary embodiment, the method can comprise fluidically coupling the fluid to the flow path arranged downstream if, due to the passive waiting for the at least partial thermal equalization and due to an additional, in particular subsequent, pressure reduction by a corresponding control of a fluid drive decompressing the fluid, the fluid has reached the target pressure (or has at least approached the target pressure, in particular asymptotically). According to this exemplary embodiment, an especially rapid and precise sample analysis can be achieved: firstly, for this purpose, after the fluid has been overcompressed to an overpressure above the target pressure, in a, for example, passive waiting step, a partial thermal equalization of the overcompressed and therefore heated fluid and cooling thereof can be waited for. Thereafter, the process of the pressure reduction, which begins during the passive waiting for the thermal equalization, can be intensified in a second stage by an actively controlled partial decompression of the fluid being carried out by means of the fluid drive. In the case of a fluid drive with a piston pump, for this purpose the piston movement direction of the fluid drive can be reversed with respect to the overcompressing and thus the piston pump can now be operated for the specifically active decompressing of the fluid. Thus, if the piston of the piston pump is moved forward during the overcompressing, the piston of the same piston pump can be moved backward during the active decompressing. As a result, the pressure of the fluid is further reduced and approaches the target pressure. According to this configuration, therefore-due to the downstream active pressure reduction by means of the fluid drive-the overcompressing to an overpressure above the target pressure can be carried out especially pronounced, which also leads to especially strong heating of the fluid. Due to the then resulting especially high temperature difference between the strongly overcompressed fluid and the environment, the (in particular passive) thermal equalization takes place especially accelerated. The remainder (or at least a further part) of the approach of the temperature curve of the fluid to the environment and its pressure towards the target pressure can then accomplish the decompressing by an active piston backward movement. As a result, it becomes possible, after the partial decompression, to bring both the pressure and the temperature of the fluid simultaneously to the corresponding target values, e.g. the fluid pressure and the fluid temperature in the system flow path. This leads to an especially high analysis accuracy and to an especially rapid implementation of an analysis method.

According to an exemplary embodiment, after the overcompressing, the method can comprise a corresponding control of a fluid drive decompressing the fluid for the pressure reduction. According to this embodiment, an explicit phase of the passive waiting for a thermal equalization before the decompressing can also be dispensed with by the compressing and the subsequent decompressing only passing moderately rapidly and the piston movement being reversed immediately after the overcompressing and an active decompression of the fluid thereby being effected while cooling the same and while approaching the target pressure. During this active decompression, the pressure of the fluid thus approaches the target pressure or even reaches the same.

According to an exemplary embodiment, the fluid to which the described pressure profile of overcompressing and subsequent pressure reduction is applied can form the fluidic sample and/or a mobile phase into which the fluidic sample is introduced for analyzing.

According to an exemplary embodiment, the control unit can be configured for carrying out a method according to any of the above-described features. In other words, a processor of the control unit can be configured to automatically execute the method steps such as have just been described as exemplary configurations.

According to an exemplary embodiment, the control unit can be configured for controlling the analyzing device for analyzing the fluidic sample. The control unit can thus be used not only for controlling the conditioning of the fluid, but also for controlling the entire analyzing device. It is alternatively also possible that the control unit is used only for controlling a fluid drive and/or a fluid valve.

In the method, the control unit and/or the analyzing device, at least one pressure sensor and/or at least one temperature sensor can be provided, with which pressure and/or temperature of the fluid and/or at least one other component of the analyzing device can be detected. Corresponding sensor data can be used for controlling or regulating a temporal pressure profile and/or temperature profile of the fluid. As a result, the suppression of artifacts can be carried out especially precisely.

According to an exemplary embodiment, the analyzing device can be configured as a sample separating device and comprise an analytical pump for driving a mobile phase and the fluidic sample introduced into the mobile phase and a sample separating unit for separating the fluidic sample introduced into the mobile phase. Here, the mobile phase and/or the fluidic sample can be the fluid. Descriptively, the analyzing device can be configured as a chromatographic sample separating device, in particular for liquid chromatography or as an HPLC.

The sample separating device can be a microfluidic measuring device, a life science device, a liquid chromatography device, a gas chromatography device, an HPLC (high-performance liquid chromatography) device, a UHPLC (ultra-high-performance liquid chromatography) device, or an SFC (supercritical liquid chromatography) device. However, many other applications are possible.

According to an exemplary embodiment, the sample separating unit can be configured as a chromatographic separating unit, in particular as a chromatographic separation column. In a chromatographic separation, the chromatographic separation column can be provided with an adsorption medium. At this, the fluidic sample can be stopped and only subsequently, in the presence of a specific solvent composition, it can be detached again fractionally, whereby the separation of the sample into its fractions is accomplished.

A pumping system for conveying fluid can be set up, for example, to convey the fluid or the mobile phase at a high pressure, for example a few 100 bar up to 1000 bar and more, through the system.

The sample separating device can comprise a sample injector for introducing the sample into the fluidic separation path. Such a sample injector can comprise an injection needle that can be coupled to a seat in a corresponding liquid path, wherein the needle can be moved out of this seat in order to receive sample, wherein after the reintroduction of the needle into the seat, the sample is located in a fluid path which, for example by switching a valve, can be switched into the separation path of the system, which leads to the introduction of the sample into the fluidic separation path. In another embodiment of the present disclosure, a sample injector or sampler can be used with a needle that is operated without a seat.

The sample separating device can comprise a fraction collector for collecting the separated components. Such a fraction collector can guide the different components of the separated sample, for example, into different liquid containers. However, the analyzed sample can also be supplied to a drain container.

The sample separating device can comprise a detector for detecting the separated components. Such a detector can generate a signal that can be observed and/or recorded and that is indicative of the presence and amount of the sample components in the fluid flowing through the system.

### BRIEF DESCRIPTION OF THE FIGURES

Other objectives and many of the attendant advantages of exemplary embodiments of the present disclosure will become readily apparent and will be better understood by reference to the following more detailed description of exemplary embodiments in conjunction with the accompanying drawings. Features that are substantially or functionally the same or similar are provided with the same reference numerals.

FIG. 1 shows an HPLC system as an analysis device according to an exemplary embodiment of the present disclosure.

FIG. 2 shows a part of an analysis device according to an exemplary embodiment of the present disclosure.

FIG. 3 shows a part of an analysis device according to an exemplary embodiment of the present disclosure.

FIG. 4 shows a diagram that illustrates a pressure profile and a temperature profile over time when carrying out methods according to exemplary embodiments of the present disclosure.

FIG. 5 shows a diagram that illustrates a piston movement, a pressure profile, a temperature deviation and a volume error as a function of time when carrying out a conventional method.

FIG. 6 shows a diagram that illustrates a piston movement, a pressure profile, a temperature deviation and a volume error as a function of time when carrying out a method according to an exemplary embodiment of the present disclosure.

FIG. 7 shows a diagram that illustrates a piston movement, a pressure profile, a temperature deviation and a volume error as a function of time when carrying out a method according to another exemplary embodiment of the present disclosure.

FIG. 8 shows a diagram that illustrates a piston movement, a pressure profile, a temperature deviation and a volume error as a function of time when carrying out a method according to yet another exemplary embodiment of the present disclosure.

The illustrations in the drawings are schematic.

### DETAILED DESCRIPTION

Before exemplary embodiments are described with reference to the drawing figures, some basic considerations will be summarized on the basis of which exemplary embodiments of the present disclosure have been derived.

In specific fields of application, such as HPLC or UHPLC, high-pressure piston pumps are required in order to provide an especially stable fluid flow. However, liquids can emit a substantial amount of heat during a compression, so that in a time interval after the compression the just compressed liquid cools and thus effects an additional virtual flow. This can be caused by a volume or pressure loss due to cooling to the ambient temperature. Such a virtual flow can cause flow rate deviations, errors and/or irregularities during the high-pressure pump operation.

According to an exemplary embodiment, a fluid (for example a mobile phase or a fluidic sample in an analyzing device configured as a liquid chromatography sample separating device) that is to be brought to a predetermined target pressure (for example a system pressure of a chromatographic separation path) is firstly brought to an overpressure higher than the target pressure by an overcompression. Thereafter, the fluid can be subjected to a pressure reduction, as a result of which the fluid approaches the target pressure or even reaches the same. As a result of the preceding overcompression, thermally-related artifacts due to heating of the fluid during compression, followed by subsequent cooling, can be suppressed or eliminated. As a result, the accuracy of an analysis run can be improved or the speed of an analysis run can be increased. Conventionally occurring density errors and resulting volume errors during direct compression of a fluid to a target pressure can thereby be suppressed or eliminated.

Excessive compression results in more rapid temperature compensation. As a result of a pressure reduction subsequent to the overcompressing (such as by active piston control and/or waiting for temperature compensation), a target pressure can then be achieved from above.

According to an exemplary embodiment, the process control can be such, for example, that the fluid is heated by 10 °C during the overcompressing. The overcompression can then be set in such a way that after the pressure reduction together with cooling by 10 °C, the target pressure is just reached.

In order to further reduce the cooling time, according to another exemplary embodiment, the fluid can be heated by 20 °C, for example, during even stronger overcompressing. As a result, especially rapid temperature compensation with the environment takes place. It can now be waited until the fluid has cooled by, for example, 10 °C. Active decompressing (for example, by an actively controlled backward movement of a piston of a fluid drive) can then be initiated, as a result of which the target pressure is reached more quickly and further cooling by, for example, a further 10 °C can be achieved.

According to an advantageous aspect, as a result of the overcompressing, it can be achieved that the target pressure can be reached more quickly or can be equilibrated more quickly to a target temperature.

According to an exemplary embodiment, an overcompression of a mobile phase can be carried out within an HPLC pump and the overcompressed mobile phase can subsequently be transferred towards the system (i.e., to the pump outlet) by a diffuser, a restriction, a pressure regulator or the like, upon passage of which the pressure is partially reduced and as a result a temperature reduction takes place. Advantageously, such an overcompression can be provided in order to completely or partially compensate for specific thermal effects. Such an overcompression can be controlled especially advantageously by means of an active valve in order to compress higher than to a target or system pressure. An overcompression according to exemplary embodiments of the present disclosure may cause not only a slight exceeding of the target or system pressure, but a significant exceeding by, for example, 10% or more. Thus, according to exemplary embodiments of the present disclosure, an intelligent fluid overcompression with heat effect suppression can be carried out.

An exemplary embodiment of the present disclosure encompasses the use of an active fluid valve in a connecting line between a cylinder that executes the compression (also referred to as primary cylinder, while exemplary embodiments also apply to all cylinders in a parallel cylinder piston pump), and the high-pressure path of the pump (also referred to as outlet valve). This allows an especially elegant and precise addressing of the thermal effects that are caused by pressure changes in the fluid.

According to an exemplary embodiment of the present disclosure, an initial fluid compression in the primary cylinder can be executed up to a pressure that is higher than the pressure in the high-pressure path of the system that can define a target pressure.

According to a first embodiment, this overcompressing can be carried out a specific time period before the fluidic connection of the primary cylinder to the system, so that the pressure in the primary cylinder is brought substantially to system pressure, i.e. to a target pressure, at a moment due to the cooling of the fluid, in which the primary cylinder is connected to the system, for example, by an active valve. In this first embodiment, the fluid can still be only slightly warmer than the environment during connection, i.e. for example the remainder of the system or the adjoining fluidic path. A disturbance of the flow can thereby be reduced.

According to a second embodiment, such an overcompression or densification can be carried out to a pressure that is noticeably higher than necessary in order to reach the system pressure after passive cooling up to the point in time of the connection to the system. In this second embodiment, the fluid in the primary cylinder can be partially decompressed after the overcompression by the piston action before connecting to the system. The resulting pressure in the primary cylinder after such a decompression can be substantially equal to the target or system pressure. If the extent of the overcompression is suitably set, the temperature of the fluid in the primary cylinder can also be substantially equal to the environment, so that a substantial or complete elimination of the undesired flow disturbances is possible. An additional advantage of the second embodiment lies in the higher fluid temperature after the overcompression. While the available time period in the first embodiment may not be completely sufficient for the fluid to cool to the temperature of the environment and some residual heat can remain in the fluid, the warmer fluid in the second embodiment can emit more heat to the environment in the same time period, so that the partial decompression can remove residual heat from the fluid. Consequently, the resulting fluid temperature at target pressure can be substantially equal to the environmental and thus the target value.

The compression and decompression stages can be carried out on the basis of estimations, calculations and/or models of the fluid behavior with respect to pressure and/or temperature. Alternatively, the primary cylinder can be equipped with or connected to a pressure sensor, which provides the relevant data as a basis for controlling. A temperature measurement in the fluid or on a cylinder wall can also be used as a basis for controlling.

The extent of the compression and decompression can be adaptive by evaluating one or more of the preceding pump cycles and correspondingly setting the compression characteristic, decompression characteristic and/or time intervals (for example the interval between compression and decompression).

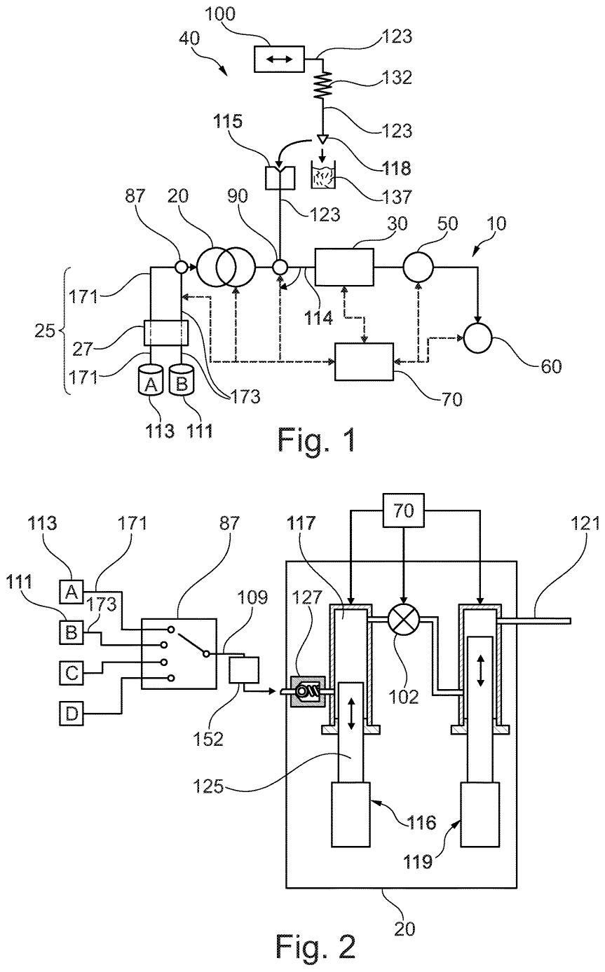

FIG. 1 shows the basic construction of an HPLC system as an example for an analysis device 10 configured as a sample separating device according to an exemplary embodiment of the present disclosure, as can be used for example for liquid chromatography. An analytical pump 20 of a fluid drive (with components 20, 100), which is supplied with solvents from a supply unit 25, drives a mobile phase through a sample separating unit 30 (such as for example a chromatographic column), which contains a stationary phase. The supply unit 25 comprises a first fluid component source 113 for providing a first fluid or a first solvent component A (for example water) and a second fluid component source 111 for providing another second fluid or a second solvent component B (for example an organic solvent). An optional degasser 27 can degas the solvents provided by means of the first fluid component source 113 and by means of the second fluid component source 111 before they are supplied to the analytical pump 20.

A sample feeding unit, which can also be referred to as injector 40, is arranged between the analytical pump 20 and the sample separating unit 30 in order firstly to receive a sample liquid or a fluidic sample from a sample container 137 into a sample receiving volume 132 in an injector path 123 (illustrated only schematically) and subsequently to introduce it into a fluidic separation path 114 between analytical pump 20 and sample separating unit 30 by switching an injection valve 90 of the injector 40. The receiving of fluidic sample from the sample container 137 can take place in particular by a sample needle 118 being moved out of a sample seat (or needle seat) 115 and moved into the sample container 137, fluidic sample is sucked out of the sample container 137 through the sample needle 118 into the sample receiving volume 132 by means of a syringe pump 100 of the fluid drive 20, 100 as a metering unit, and the sample needle 118 is then moved back into the needle seat 115.

The stationary phase of the sample separating unit 30 is provided for separating components of the sample. A detector 50, which can comprise a flow cell, detects separated components of the sample. A fractionizing device or fractionator 60 can be provided for outputting separated components of the sample into containers provided for this purpose. Liquids that are no longer required can be output into a drain container or into a waste line (not shown).

While a liquid path between the analytical pump 20 and the sample separating unit 30 is typically under high pressure, the sample liquid is firstly introduced under normal pressure into a region separated from this liquid path, namely the sample loop or the sample receiving volume 132, of the sample feeding unit or of the injector 40. The sample liquid is then introduced into the separation path 114 under high pressure. A sample receiving volume 132 (also referred to as a sample loop) can denote a portion of a fluid line that is designed for receiving or temporarily storing a predetermined amount of fluidic sample. In an embodiment, even before the sample liquid initially under normal pressure in the sample receiving volume 132 is connected into the separation path 114 under high pressure, the content of the sample receiving volume 132 is brought to and even above the system pressure of the analyzing device 10 (configured, e.g., as an HPLC) by means of the syringe pump 100. Here, the system pressure is the high pressure in the separation path 114. A control unit 70 controls the individual components 20, 25, 30, 40, 50, 60, 90, 100, etc., of the analyzing device 10.

FIG. 1 shows two supply lines 171, 173, each of which is fluidically coupled to a respective one of the two solvent containers designated as fluid component sources 113, 111 for providing a respective one of the fluids or solvent components A and B. The respective fluid or the respective solvent component A or B is conveyed through the respective supply line 171 or 173, through the degasser 27 to a proportioning valve 87 as proportioning unit, at which the fluids or solvent components A or B from the supply lines 171, 173 are combined with one another. To the proportioning valve 87, the fluid packets flow from the supply lines 171, 173, which are mixed in the later course to form a homogeneous solvent composition. The latter is then supplied to the analytical pump 20.

During operation of the analyzing device 10 and in particular of the injector 40, the injection valve 90 is switched by means of the control unit 70 for injecting a fluidic sample from the sample receiving volume 132 into a mobile phase in the separation path 114 between the analytical pump 20 and the sample separating unit 30 of the analyzing device 10. This switching of the injection valve 90 takes place to effect a relative movement between a first valve body (which can be a stator at rest with respect to a laboratory system) and a second valve body (which can be a rotor rotatable with respect to the laboratory system) of the injection valve 90. The first valve body may be provided with multiple ports and optionally with one or more groove-shaped connecting structures. The second valve body, in contrast, can be equipped with multiple groove-shaped connecting structures in order to thereby selectively fluidically couple or decouple respective ones of the ports of the first valve body depending on a respective relative orientation between the first valve body and the second valve body by means of the at least one connecting structure of the second valve body. Descriptively, a respective groove-shaped connecting structure of the second valve body can fluidically connect two (or more) of the ports of the first valve body to one another in specific switching states of the injection valve 90 and form a fluidic decoupling between other ones of the ports of the first valve body. In this manner, the individual components of the analyzing device 10 can be brought into an adjustable fluidic (de-)coupling state with one another depending on a respective operating state of the injector 40.

The control unit 70 according to FIG. 1 functions for controlling the mobile phase configured as a fluid in the region of the analytical pump 20 and the fluidic sample likewise configured as a fluid in the region of the injector 40. The control unit 70 is configured for overcompressing the respective fluid (i.e. the mobile phase or the fluidic sample) to an overpressure (see Pmax in FIG. 4) above a target pressure (see Psystem in FIG. 4), and for subsequently reducing the pressure of the fluid towards the target pressure (Psystem).

According to FIG. 1, in particular a primary piston pump of the analytical pump 20 brings the mobile phase to a high pressure before the mobile phase brought to high pressure is introduced into the separation path 114 between the analytical pump 20 and the sample separating unit 30. For example, the pressure at an inlet of the sample separating unit 30 can be 1500 bar. According to the exemplary embodiment shown, a control of the analytical pump 20 can be configured by means of the control unit 70 in such a way that the solvent composition and the flow rate of the mobile phase that the sample separating unit 30 achieves can be set especially quickly and precisely. Descriptively, this is achieved by the control unit 70 controlling the analytical pump 20 in such a way that the mobile phase is brought to an overpressure of, for example, 1600 bar, for example in a primary piston pump of the two-stage analytical pump 20, that is to say the mobile phase is overcompressed with respect to the actual target or system pressure of 1500 bar. During this overcompression, an active control valve between the primary piston pump and the secondary piston pump of the analytical pump 20 can be closed such that the overcompressed fluid cannot evade (or escape). During this overcompression, the fluid configured as the mobile phase is brought to an overcompressed overpressure of 1600 bar, for example, that is to say to an overpressure above the system or target pressure of 1500 bar in the shown example. Here, strong heating of the mobile phase occurs. Before opening the fluid valve for transferring the mobile phase brought to overpressure into the separation path 114, it can therefore firstly be waited until the heated mobile phase is at least partially cooled. Then, the piston of the primary piston pump of the analytical pump 20 can be moved back in a defined way in order to additionally actively decompress the mobile phase and thereby further convey the pressure reduction. Here, further cooling of the mobile phase occurs, for example to its preceding temperature or ambient temperature. Here, the mobile phase can also reach the target pressure of, for example, 1500 bar. The actively controlled fluid valve at the outlet of the primary piston pump of the analytical pump 20 can now be opened such that the mobile phase is connected to the target or system pressure of 1500 bar in the separation path 114. Thermal artifacts can be avoided here and the flow rate of the mobile phase in the separation path 114 can correspond to a desired flow rate with high accuracy.

Alternatively or additionally, the fluidic sample that is handled by means of the syringe pump 100 in the injector 40 can also be pressure-configured in order to avoid artifacts when introducing the fluidic sample from the sample receiving volume 132 into the separation path 114. Still in the injector path 123, the fluidic sample in the sample receiving volume 132 can be brought to a pressure above a target pressure that can correspond for example to the system pressure in the separation path 114 by means of a forward movement of a piston of the syringe pump 100. If the fluidic sample in the sample receiving volume 132 is brought from ambient pressure to high pressure only by the introduction into the separation path 114, this can generate pressure surges that in turn can limit the separation accuracy of the separation run and also the service life of the components involved. In order to avoid such disadvantages according to the shown embodiment, the fluidic sample in the sample receiving volume 132 can even be brought to a pressure above the target pressure of for example 1500 bar, for example to 1600 bar, by means of the syringe pump 100 even before the introduction into the separation path. As a result, the fluidic sample is initially heated but then slightly cools by waiting. Subsequently, the piston of the syringe pump 100 can be specifically moved back in order to effect an additional active pressure reduction of the fluidic sample in the sample receiving volume 132. If the fluidic sample has as a result reached the target pressure of 1500 bar and has been cooled here for example to its previous temperature, the injection valve 90 can be switched such that the fluidic sample is introduced from the sample receiving volume into the separation path 114. On the one hand, undesired pressure surges are avoided by the precompressing. Furthermore, fluidic artifacts in connection with the possible thermal expansion of the fluidic sample are avoided by the overcompressing and the subsequent pressure reduction before the introduction by switching the injection valve 90. This in turn accelerates the sample separation or increases the accuracy thereof.

The sequence of the overcompressing and subsequent decompressing can be carried out either only for the mobile phase by the analytical pump 20 or only for the fluidic sample in the injector 40, or for both fluids (that is to say for the mobile phase and for the fluidic sample).

FIG. 2 shows a part of an analysis device 10 according to an exemplary embodiment of the present disclosure. More precisely, FIG. 2 shows an example of the supply unit 25 shown in FIG. 1 with downstream analytical pump 20 of an analysis device 10 according to an exemplary embodiment of the present disclosure.

The control unit 70 according to FIG. 2 serves for controlling the mobile phase in the region of the analytical pump 20. The control unit 70 is configured for overcompressing the mobile phase to an overpressure (see Pmax in FIG. 4) above a target pressure (see Psystem in FIG. 4), and for subsequently reducing the pressure of the mobile phase towards the target pressure (Psystem).

According to FIG. 2, solvent A, and optionally solvents B, C, D from corresponding solvent containers 111, 113, etc., are conducted through corresponding fluid lines 171, 173 to an optional proportioning valve 87. As a result, individual fluid packets of the solvents A, B, C, D are coupled successively into a fluid line 109. This mobile phase can be mixed in an optional mixer 152. The mobile phase then passes through an inlet valve 127 into a primary piston pump 116 of the analytical pump 20. At the outlet of the primary piston pump 116 is located a fluid valve 102 that can be actively controlled by means of the control unit 70. Downstream of the actively controllable fluid valve 102, a secondary piston pump 119 is mounted. The latter conveys the fluid from the primary piston pump 116 into a connected fluid line 121 that can be connected for example to the injection valve 90 shown in FIG. 1.

During operation, the control unit 70 can control the piston pumps 116, 119 and the actively switchable fluid valve 102. In order to bring the mobile phase to a target or system pressure, the control unit 70 can first control the primary piston pump 116 in such a way that the mobile phase is overcompressed to an overpressure of, for example, 1600 bar above a target or system pressure of, for example, 1500 bar. As a result, strong compression and heating of the mobile phase occurs. It can now be waited until the mobile phase is at least partially cooled. Advantageously, a piston 125 of the primary piston pump 116 can now be actively retracted in order to partially decompress the mobile phase in a piston chamber 117. As a result, the overcompressed mobile phase is pressure-reduced and quickly reaches its initial or target temperature and the target pressure. The previously closed actively controlled fluid valve 102 can now be opened such that the mobile phase now at target pressure is first conveyed into the secondary piston pump 119 and then into the connected fluid line 121. Thermal artifacts are effectively prevented in the case of the described indirect compression to system pressure.

Alternatively, as for example in a parallel pump, the valve 102 can be connected directly to the system fluid line 121. In this case, the compressed and subsequently partially pressure-reduced fluid is conveyed directly from the first cylinder 117 via the valve 102 into the system.

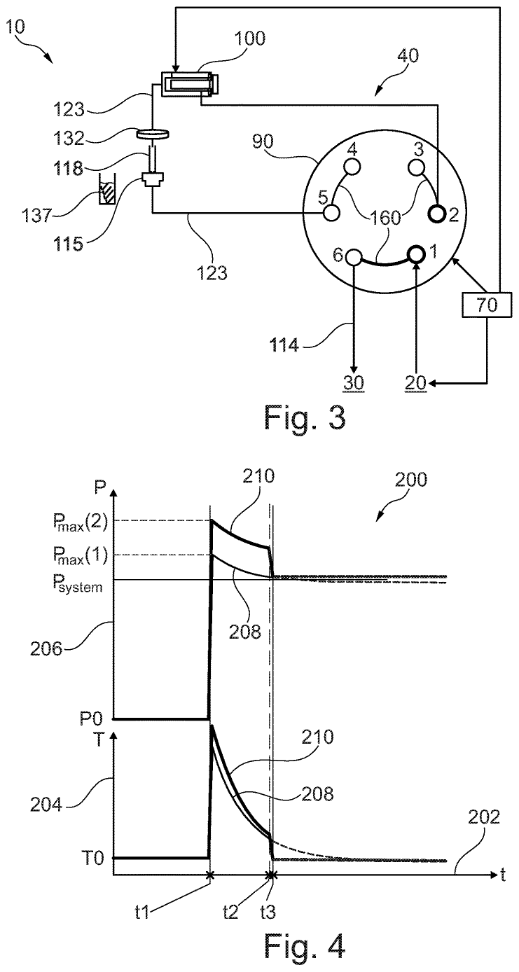

FIG. 3 shows a part of an analysis device 10 according to an exemplary embodiment of the present disclosure. More precisely, FIG. 3 shows an injector 40 of an analysis device 10 according to an exemplary embodiment of the present disclosure.

The control unit 70 according to FIG. 3 operates for controlling the fluidic sample in the region of the injector 40. The control unit 70 is configured for overcompressing the fluidic sample to an overpressure (see Pmax in FIG. 4) above a target pressure (see Psystem in FIG. 4), and for subsequently reducing the pressure of the fluidic sample towards the target pressure (Psystem).

The injection valve 90 shown is installed in the liquid chromatography analysis device 10 for separating a fluidic sample. As can be seen in FIG. 3, the analysis device 10 comprises an analytical pump 20 configured as a high-pressure pump for driving a mobile phase (i.e. a solvent or a solvent composition) and a fluidic sample to be injected into the mobile phase by means of the injector 40. The fluidic sample is to be separated into its fractions by means of the analysis device 10. The actual separation takes place by means of the sample separating unit 30 configured as a chromatographic separation column after the injection of the fluidic sample into the mobile phase.

Here, the injection valve 90 of the injector 40 shown in FIG. 3 serves for injecting the fluidic sample into the mobile phase in a separation path 114 between the analytical pump 20 and the sample separating unit 30. For this purpose, the injector 40 comprises a sample receiving volume 132 configured for example as a sample loop for receiving a predeterminable volume of the fluidic sample. Further, the injector 40 shown in FIG. 3 contains a metering unit configured for example as a syringe pump 100 with a movable piston for metering the fluidic sample to be received in the sample receiving volume 132.

Furthermore, the injector 40 has a movable needle 118 that can be received in a fluid-tight manner in a needle seat 115 for receiving the needle 118 in a fluid-tight manner. Furthermore, the needle 118 can also be moved out of the needle seat 115 and introduced into a sample container 137 with fluidic sample in order then to suck fluidic sample out of the sample container 137 through the needle 118 into the sample receiving volume 132 by means of moving back the piston of the syringe pump 100. The movement of the needle 118 between the needle seat 115 and the sample container 137 can take place by means of a movement apparatus (in particular by means of a robot arm) that is not shown in FIG. 3.

The injection valve 90 configured as a rotor valve in the exemplary embodiment shown has stationary ports or fluid connections marked 1 to 6, of which a part is connected to rotatable grooves 160. Different fluid connection paths can be set by means of the rotatable grooves 160.

As shown in FIG. 3, the control unit 70 controls inter alia the syringe pump 100 that accomplishes a metering of the fluidic sample in the sample receiving volume 132 in the described way. Once the fluidic sample has been drawn into the sample receiving volume 132 and the sample needle 118 has been moved back into the sample seat 115, the syringe pump 100 is controlled by means of the control unit 70 so that the fluidic sample is first brought to a pressure above a target pressure in the separation path 114 between the analytical pump 20 and the sample separating unit 30. If the target pressure is for example 1500 bar, the fluidic sample in the sample receiving volume 132 is for example first overcompressed to 1600 bar by a forward movement of the piston of the syringe pump 100. This is followed by a waiting phase in which the fluidic sample in the sample receiving volume 132 cools quickly after heating by the overcompressing. Subsequently, the piston of the syringe pump 100 can be moved back in order to accomplish an active further pressure reduction of the fluidic sample in the sample receiving volume 132. Only when the fluidic sample in the sample receiving volume 132 has reached the target pressure and has cooled to its previous temperature or a sufficiently low temperature, the injection valve 90 is switched in order to introduce the fluidic sample from the sample receiving volume 132 into the separation path 114. Artifacts in connection with density or volume fluctuations of the fluidic sample are now not to be feared since the fluidic sample is at an appropriate temperature and at the target pressure. It can additionally be achieved by the precompressing that pressure surges when introducing the fluidic sample into the separation path 114 do not occur.

FIG. 4 shows a diagram 200 that illustrates a pressure profile (P) and a temperature profile (T) as a function of time (t) when carrying out methods according to exemplary embodiments of the present disclosure.

FIG. 4 thus shows diagram 200 with pressure and temperature profiles when processing a fluid according to exemplary embodiments of the present disclosure. The diagram 200 shown in FIG. 4 has an abscissa 202 along which the time t is plotted. A profile of the temperature T is plotted along a first ordinate 204. A profile of the pressure P is plotted along a second ordinate 206. An ambient pressure P0 (for example 1 bar) and an ambient temperature T0 (for example 20 °C) are shown in FIG. 4. First curves 208 are shown for the ordinates 204, 206 in a process control according to a first exemplary embodiment. Second curves 210 are shown for the ordinates 204 and 206 for a process control according to a second exemplary embodiment of the present disclosure.

According to the process control of FIG. 4, an overcompressing and a subsequent pressure reduction of the fluid take place in such a controlled way that compression-related thermal artifacts are thereby at least partially suppressed. These at least partially suppressed compression-related thermal artifacts comprise a flow rate deviation of the fluid due to heating caused by the overcompressing and subsequent cooling of the fluid.

In the two methods described with reference to FIG. 4, after the overcompressing for the pressure reduction, passive waiting for an at least partial thermal equalization of the overcompressed fluid with a thermal environment takes place from a point in time tl and only subsequently fluidically coupling the fluid to a flow path arranged downstream at a point in time t3.

According to a first embodiment according to reference numeral 208, the fluidic coupling of the fluid to the flow path arranged downstream takes place if, due to the passive waiting for the at least partial thermal equalization, the fluid has reached a target pressure Psystem.

According to a second embodiment according to reference numeral 210, the fluidic coupling of the fluid to the flow path arranged downstream takes place if, due to the passive waiting for the partial thermal equalization in a time period from t1 to t2 and due to an additional subsequent pressure reduction in a time period from t2 to t3 by a corresponding control of a fluid drive 20 and/or 100 decompressing the fluid, the fluid has reached the target pressure Psystem.

This is described in more detail below:

In the first exemplary embodiment according to reference numeral 208, a fluid is firstly brought to an overpressure Pmax(1) above a target or system pressure Psystem at the point in time t1 starting from ambient pressure P0 and ambient temperature T0. For example, the target pressure Psystem is 1500 bar and the first overpressure Pmax(1) is 1550 bar. As a result of the overcompression, heating of the fluid occurs, as can be read at the first ordinate 204 for the curve with reference numeral 208. It is now waited until the fluid is sufficiently cooled. This takes place up to the point in time t 3. As can be seen from reference numeral 208 at the second ordinate 206, the pressure of the fluid has now approximately reached the target pressure Psystem. Further conveying of the fluid thus obtained into a connected fluidic system will not lead to large fluctuations of density, volume and flow rate of the fluid since, during further processing of the fluid, the latter is at a pressure close to the target pressure Psystem and at a sufficiently low temperature close to the ambient temperature T0.

An even more advantageous configuration can be achieved with the second exemplary embodiment according to reference numeral 210. As can be seen in the second ordinate 206 and the reference numeral 210 there, in this embodiment, the overcompression can take place at the point in time t1 beyond the target pressure Psystem to an even higher overpressure Pmax(2) (which can be larger than Pmax(1)). This leads to an especially strong temperature increase of the fluid at the point in time t1, see reference numeral 210 at ordinate 204. Due to the now larger temperature difference between the fluid and the environment, even more rapid temperature compensation occurs than in the first exemplary embodiment. This is therefore followed by a passive waiting time up to the point in time t2, for example until the fluid has equalized half or 80% of its heating. An additional rapid and active pressure reduction of the fluid can now be accomplished by an active backward movement of a piston of a fluid drive 20, 100 for driving the fluid, as can be seen from reference numeral 210 in ordinate 206 at the point in time t 2. After a very short additional time, the fluid reaches the system pressure Psystem or approximately this pressure at the point in time t3. With especially rapid process control, it can now be achieved that no fluctuations of density, volume or flow rate of the fluid occur.

The measures described according to FIG. 4 can be carried out, for example, for a mobile phase in an analytical pump 20 and/or on a fluidic sample in an injector 40.

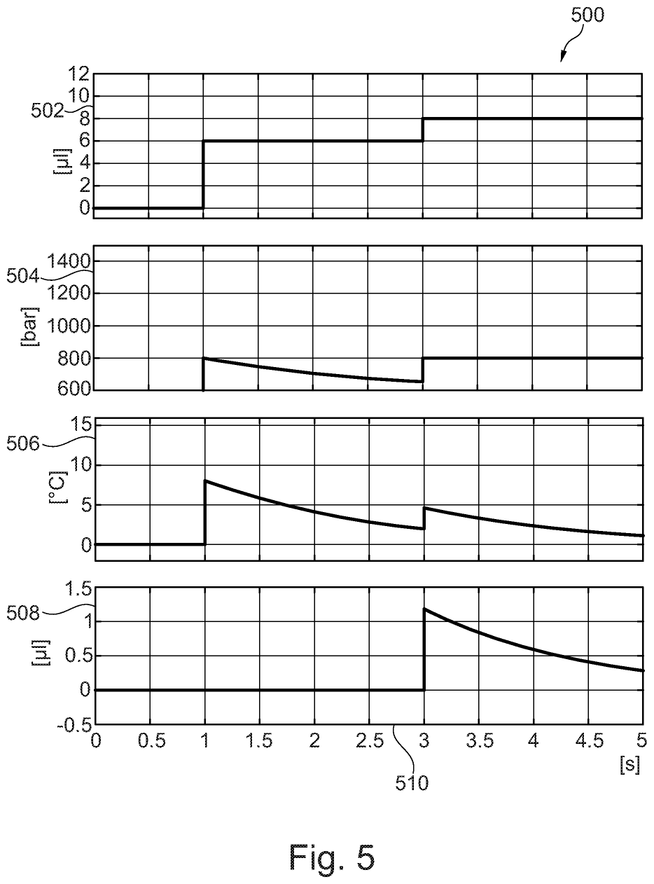

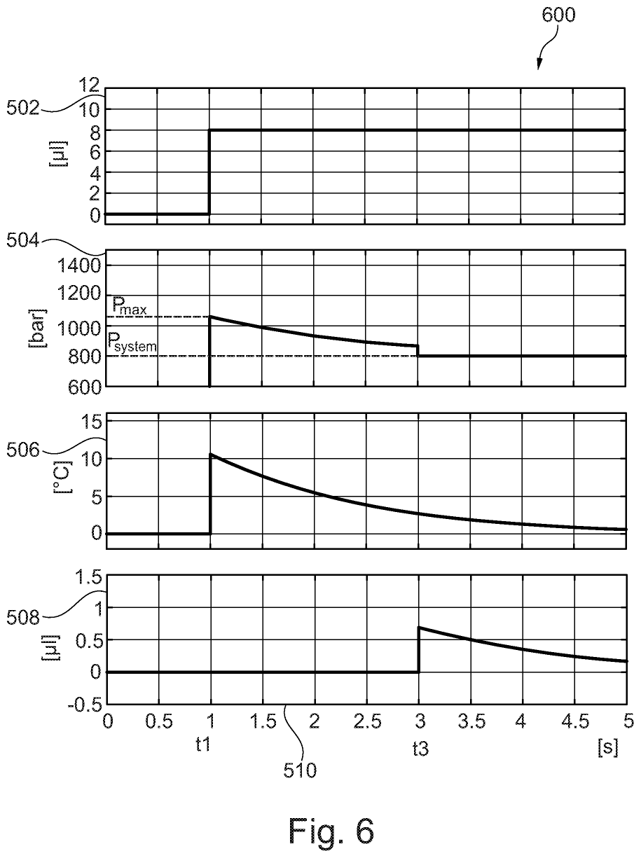

Different process controls are described below with reference to FIG. 5 to FIG. 8. FIG. 5 shows a conventional process control. FIGS. 6 to 8 show process controls according to exemplary embodiments of the present disclosure in which volume errors can be reduced or even eliminated compared to the conventional procedure according to FIG. 5.

FIG. 5 shows a diagram 500 that illustrates a piston movement (see ordinate 502, the value in μl corresponds to current cylinder volume under the piston), a pressure profile (see ordinate 504), a temperature deviation (see ordinate 506) and a volume error (see ordinate 508) as a function of time (see abscissa 510) when carrying out a conventional method.

According to the conventional approach of FIG. 5, first a compression to a pressure equal to the target pressure or less than the target pressure takes place and then a post-compression. At a point in time of 3 seconds, a movement of the piston of a piston pump to the target position takes place and a connection of the container with the compressed fluid to the system is created. From the point in time of 3 seconds, a target pressure therefore prevails (assuming a much higher system elasticity than the elasticity of the container with the fluid). As can be seen in FIG. 5, a considerable volume error occurs. A temperature deviation from a point in time of 3 seconds is shown as a hypothetical value.

FIG. 6 shows a diagram 600 that illustrates a piston movement (see ordinate 502), a pressure profile (see ordinate 504), a temperature deviation (see ordinate 506) and a volume error (see ordinate 508) as a function of time (see abscissa 510) when carrying out a method according to an exemplary embodiment of the present disclosure.

FIG. 6 shows the piston movement with overcompressing according to an exemplary embodiment of the present disclosure, in which the piston is moved immediately to the target position. This initially results in an overcompression. At a point in time t3 of 3 seconds, a connection of the container with the compressed fluid to the system is created. From the point in time t3 of 3 seconds, a target pressure therefore prevails (again assuming a much higher system elasticity than the elasticity of the container with the fluid). As a comparison of FIG. 5 with FIG. 6 shows, the volume error is significantly lower in the exemplary embodiment according to FIG. 6 than according to FIG. 5.

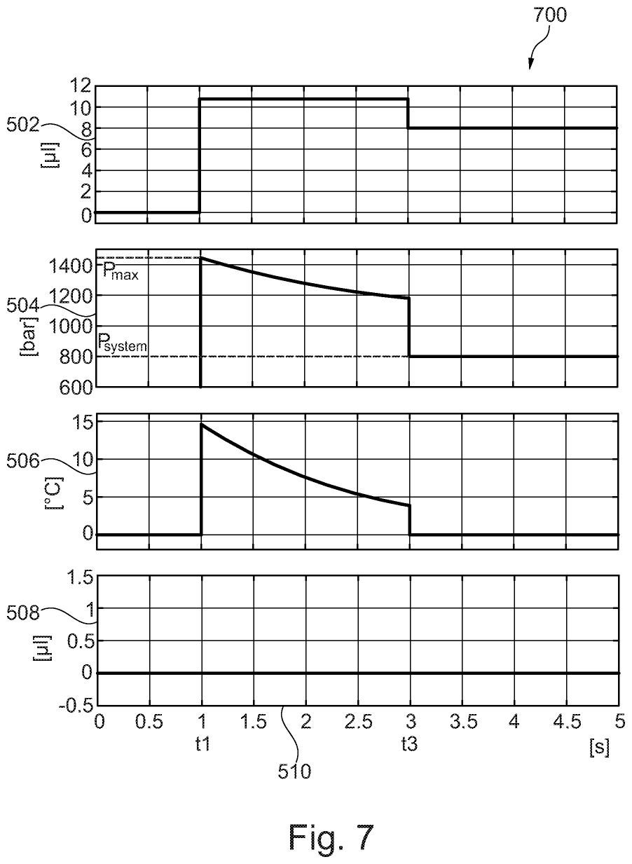

FIG. 7 shows a diagram 700 that illustrates a piston movement (see ordinate 502), a pressure profile (see ordinate 504), a temperature deviation (see ordinate 506) and a volume error (see ordinate 508) as a function of time (see abscissa 510) when carrying out a method according to another exemplary embodiment of the present disclosure.

According to FIG. 7, a piston movement with overcompressing and with subsequent partial decompression takes place according to another exemplary embodiment of the present disclosure. At a point in time t3 of 3 seconds, the partial decompression takes place and a connection of the container with the compressed fluid to the system is created. The decompression brings the compressed fluid to the target temperature and the target pressure, whereby the temperature deviation and the resulting volume error can be completely or almost completely eliminated.

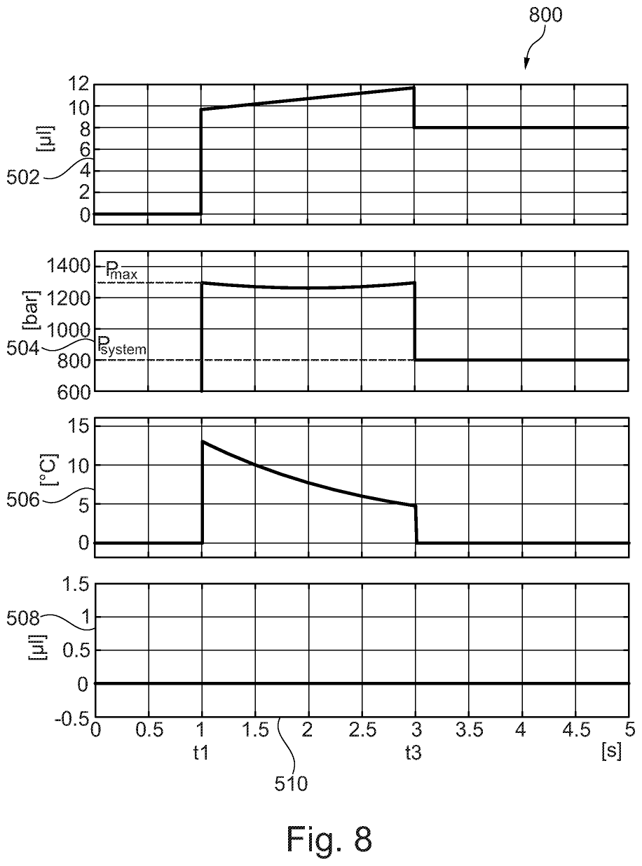

FIG. 8 shows a diagram 800 that illustrates a piston movement (see ordinate 502), a pressure profile (see ordinate 504), a temperature deviation (see ordinate 506) and a volume error (see ordinate 508) as a function of time (see abscissa 510) when carrying out a method according to yet another exemplary embodiment of the present disclosure.

FIG. 8 shows a piston movement with overcompressing and with subsequent partial decompression according to a further exemplary embodiment of the present disclosure. After initial overcompression, a further forward movement of the piston takes place while the compressed fluid releases the heat to the environment. As a result, the heat can be dissipated especially efficiently with strong reduction or even minimization of the necessary overcompression.

Generally, according to exemplary embodiments of the present disclosure, a multistage or temporally extended compression or decompression is possible. Thus, the overcompression can be carried out according to a predetermined temporal overcompression profile and/or the subsequent pressure reduction can be carried out according to a predetermined temporal pressure reduction profile.

At a point in time t3 of 3 seconds, the partial decompression takes place and a connection of the container with the compressed fluid to the system is created. The decompression brings the compressed fluid to the target temperature and the target pressure, whereby the temperature deviation and the resulting volume error can be completely or almost completely eliminated.

Thus, in the exemplary embodiment according to FIG. 8, after the overcompressing at the point in time t1 and before the subsequent pressure reduction at the point in time t3, the method can comprise an intermediate time period in which the pressure of the fluid is kept substantially constant, see ordinate 504 in the time period between t1 and t3. As is shown from ordinate 502, this is achieved according to FIG. 8 by means of continued forward movement of the piston of the fluid drive 20, 100 in the intermediate time period. This continued forward movement of the piston results in substantially complete compensation for an effect of a temperature equalization of the fluid (see ordinate 506) on the pressure.

It should be noted that the term “comprise” does not exclude other elements and that the term “a” does not exclude a plurality. Elements described in connection with different exemplary embodiments can also be combined. The numerical values of pressure, temperature and time in the diagrams are likewise shown as exemplary example values. It should also be noted that reference signs in the claims should not be interpreted as limiting the scope of protection of the claims.

1. A method of controlling a fluid in an analyzing device for analyzing a fluidic sample, the method comprising:
overcompressing the fluid to an overpressure above a target pressure; and
subsequently reducing the pressure of the fluid towards the target pressure;
wherein the overcompressing and the subsequent reducing of the pressure of the fluid is done by operating a fluid drive of the analyzing device.

2. The method of claim 1, comprising subsequently reducing the pressure of the fluid until the target pressure is reached.

3. The method of claim 1, wherein the fluid drive comprises a piston pump that operates by advancing a piston of the piston pump for overcompressing and/or by retracting the piston of the piston pump for subsequently reducing the pressure.

4. The method of claim 1, comprising overcompressing the fluid to the overpressure by the fluid drive and by of temporarily closing a fluid valve.

5. The method of claim 4, comprising at least one of the following features:
wherein the method comprises actively controlling the fluid valve by temporarily closing the fluid valve for overcompressing and by subsequently opening the fluid valve;
wherein the method comprises controlling the fluid valve as an overpressure valve, which is configured to open only when a predetermined pressure value above the target pressure is reached;
wherein the fluid valve is arranged at an outlet of the fluid drive or downstream of the fluid drive.

6. The method of claim 1, comprising at least one of the following features:
wherein the method comprises overcompressing the fluid to the overpressure by the fluid drive and by temporarily shutting off a flow path portion of the analyzing device containing the fluid drive and the fluid;
wherein the fluid drive forms at least a part of an analytical pump configured to convey the fluidic sample and a mobile phase formed by the fluid to a sample separating unit of the analyzing device;
wherein the fluid drive comprises a metering unit configured to draw up the fluidic sample formed by the fluid in an injector of the analyzing device;
wherein the fluid drive comprises a syringe pump configured to draw up the fluidic sample formed by the fluid in an injector of the analyzing device.

7. The method of claim 1, comprising at least one of the following, after the reducing of the pressure of the fluid:
introducing the fluidic sample into the fluid configured as a mobile phase for analyzing the fluidic sample;
introducing the fluidic sample into the fluid configured as a mobile phase for separating the fluidic sample in a sample separating unit of the analyzing device;
introducing the fluidic sample into the fluid configured as a mobile phase for chromatographically separating the fluidic sample.

8. The method of claim 1, comprising at least one of the following features:
wherein the overpressure reached by the overcompressing is at least 1.1 times the target pressure;
wherein the overpressure reached by the overcompressing is at least 1.2 times the target pressure;
wherein the overpressure reached by the overcompressing is at least twice the target pressure;
wherein the overpressure reached by the overcompressing is at most 1.5 times the target pressure;
wherein the overpressure reached by the overcompressing is at most three times the target pressure;
wherein the overpressure reached by the overcompressing is at least 50 bar higher than the target pressure;
wherein the overpressure reached by the overcompressing is at least 100 bar higher than the target pressure;
wherein the overpressure reached by the overcompressing is at most 500 bar higher than the target pressure;
wherein the overpressure reached by the overcompressing is at most 1000 bar higher than the target pressure;
wherein the target pressure is in a range from 200 bar to 2000 bar;
wherein the target pressure is in a range from 1000 bar to 1500 bar.

9. The method of claim 1, comprising at least one of:
controlling the overcompressing and the subsequent reducing of the pressure of the fluid such that compression-related thermal artifacts are thereby at least partially suppressed;
controlling the overcompressing and the subsequent reducing of the pressure of the fluid such that compression-related thermal artifacts are thereby at least partially suppressed, wherein at least a part of the at least partially suppressed compression-related thermal artifacts is a flow rate deviation of the fluid due to heating caused by the overcompressing and subsequent cooling of the fluid.

10. The method of claim 1, wherein the target pressure is a pressure in a target flow path of the analyzing device downstream of a control flow path of the analyzing device in which the overcompressing and the subsequent reducing of the pressure of the fluid are done.

11. The method of claim 1, comprising at least one of the following:
after the overcompressing and the subsequent reducing of the pressure of the fluid, fluidically coupling the fluid to a flow path of the analyzing device arranged downstream from at least a portion of the fluid drive;
after the overcompressing of the fluid, passively waiting for an at least partial thermal equalization of the overcompressed fluid with a thermal environment for pressure reduction of the fluid, and subsequently fluidically coupling the fluid to a flow path of the analyzing device arranged downstream from at least a portion of the fluid drive.

12. The method of claim 1, comprising, after the overcompressing of the fluid:
passively waiting for an at least partial thermal equalization of the overcompressed fluid with a thermal environment for pressure reduction of the fluid; and
subsequently fluidically coupling the fluid to a flow path of the analyzing device arranged downstream from at least a portion of the fluid drive,
wherein the method further comprises one of the following features:
fluidically coupling the fluid to the flow path arranged downstream if, due to the passive waiting for the at least partial thermal equalization, the fluid has reached the target pressure or has sufficiently approached the target pressure;
fluidically coupling the fluid to the flow path arranged downstream if, due to the passive waiting for the at least partial thermal equalization and due to an additional, subsequent pressure reduction by a corresponding control of the fluid drive decompressing the fluid, the fluid has reached the target pressure.

13. The method of claim 1, comprising, after the overcompressing of the fluid, controlling the fluid drive to decompress the fluid for pressure reduction of the fluid.

14. The method of one claim 1, wherein after the overcompressing of the fluid and before the subsequent reducing of the pressure of the fluid, the method comprises at least one of the following:
an intermediate time period in which the pressure of the fluid is kept substantially constant;
an intermediate time period in which the pressure of the fluid decreases according to a time-dependent profile,
an intermediate time period in which the pressure of the fluid increases;
an intermediate time period in which the pressure of the fluid increases due to a continued forward movement of a piston of the fluid drive in the intermediate time period for substantially or completely compensating for an effect of a temperature equalization of the fluid on the pressure of the fluid.

15. The method of claim 1, wherein the fluid forms the fluidic sample and/or forms a mobile phase into which the fluidic sample is introduced for analyzing by the analyzing device.

16. A control unit for controlling a fluid in an analyzing device for analyzing a fluidic sample, wherein the control unit is configured to control an operation comprising:
overcompressing the fluid to an overpressure above a target pressure; and
subsequently reducing the pressure of the fluid towards the target pressure;
wherein the overcompressing and the subsequent reducing of the pressure of the fluid is done by operating a fluid drive of the analyzing device.

17. The control unit of claim 16,
wherein the control unit is configured to control the analyzing device for analyzing the fluidic sample.

18. An analyzing device for analyzing a fluidic sample using a fluid, the analyzing device comprising:
the control unit of claim 16 for controlling the fluid; and
the fluid drive.

19. The analyzing device of claim 18, comprising:
an analytical pump configured to drive a mobile phase and the fluidic sample introduced into the mobile phase; and
a sample separating unit configured to separate the fluidic sample introduced into the mobile phase,
wherein the fluid forms the mobile phase and/or the fluidic sample.

20. The analyzing device of claim 18, further comprising at least one of the following features:
the analyzing device is configured for analyzing at least one physical, chemical and/or biological parameter of the fluidic sample;
the analyzing device is configured as a sample separating device for separating the fluidic sample;
the analyzing device is configured as a chromatography device;
the analyzing device is configured as a microfluidic device;
the analyzing device is configured as a nanofluidic device;
the analyzing device comprises a sample separating unit configured to separate the fluidic sample;
the analyzing device comprises a sample separating unit configured as a chromatographic separating unit for chromatographically separating the fluidic sample;
the analyzing device comprises an analytical pump configured to drive a mobile phase and the fluidic sample at a pressure of at least 500 bar;
the analyzing device comprises an analytical pump configured to drive a mobile phase and the fluidic sample at a pressure of at least 1000 bar;
the analyzing device comprises an analytical pump configured to drive a mobile phase and the fluidic sample at a pressure of at least 1500 bar;
the analyzing device comprises an injector configured to inject the fluidic sample into a mobile phase;
the analyzing device comprises a detector configured to detect the analyzed fluidic sample;
the analyzing device comprises a fractionator configured to collect separated fractions of the fluidic sample.
